(19) United States
(12) Patent Application Publication
(10) Pub. No.: US 2013/0342309 A1
(43) Pub. Date: Dec. 26, 2013

(54) APPARATUS AND METHOD FOR LIMITING THE USE OF AN ELECTRONIC DISPLAY

(71) Applicant: Ming Jiang, Santa Clara, CA (US)

(72) Inventor: Ming Jiang, Santa Clara, CA (US)

(21) Appl. No.: 14/003,439

(22) PCT Filed: May 7, 2012
(86) PCT No.: PCT/US12/36806

§ 371 Date: Sep. 5, 2013

Related U.S. Application Data
(60) Provisional application No. 61/483,740, filed on May 8, 2011.
(60) Provisional application No. 61/590,260, filed on Jan. 24, 2012.

(51) Int. Cl. G06F 3/14

(52) U.S. Cl. CPC G06F 3/14
USPC 340/3.1

(57) ABSTRACT

Provided are custom computing devices, program codes and methods for limiting the use of an electronic display, by determining whether a user is viewing an electronic display by obtaining the location of the user relative to the display, measuring the overall time during which the user views the display, and deactivating the display when the overall time reaches a threshold or in response to an administrator's request.

### CROSS-REFERENCE TO RELATED APPLICATIONS

This application claims priority under 35 U.S.C. §119(e) to U.S. Provisional Application Ser. No. 61/483,740 filed May 8, 2011 and U.S. Provisional Application Ser. No. 61/590,260 filed Jan. 24, 2012, the contents of which are each incorporated by reference into the present disclosure.

### FIELD OF THE DISCLOSURE

Provided embodiments of the present disclosure generally relate to devices and methods for limiting the use of electronic displays.

### BACKGROUND

Use of electronic displays (screens), such as televisions, computer screens and smart phone screens is prevalent in our life. People, in particular children, tend to watch screens too closely and/or for too long. A proper watching distance and limited continuous viewing of screens can help reduce radiation effects, maintain a good vision and prevent addiction to certain electronic activities. In many situations, however, the use of a screen by a child is not under the direct monitoring of an adult, such that the child may watch the screen too closely or use it for too long. Even for an adult, unhealthy use of a screen is common, in particular when the adult is engaged in prolonged computer task or addictive electronic activities. There is a need, therefore, to provide a mechanism to correct such unhealthy use or at least alert the user about the risk of uncontrolled use of screens.

### SUMMARY OF THE DISCLOSURE

The disclosure, in one embodiment, provides methods for limiting the user of an electronic display. Computing devices and computer-readable media embedding program code for carrying out the methods are also provided. In one embodiment, the method comprises determining whether a user is viewing an electronic display by obtaining the location of the user relative to the display, measuring the overall time during which the user views the display, and deactivating the display when the overall time reaches a threshold or in response to an administrator's request.

In one aspect, the location of the user relative to the display comprises a distance between the user and the display and the user is determined as viewing the display if the distance is smaller than a distance limit. In another aspect, the location of the user comprises the locations of the pupils of the user relative to the display.

In one aspect, the overall time is continuous. In another aspect, the overall time is accumulative time during which the user views the display.

In some aspects, the deactivation comprises starting a screensaver. In some aspects, the deactivation comprises displaying a warning message on the display, turning off the display or displaying a content that is different from what has been displayed before the deactivation. In some aspects, the content is transmitted from a server over a network.

The display is deactivated, in one aspect, when the overall time reaches the threshold. In one aspect, the threshold is predetermined. In another aspect, the threshold is determined based on the distance between the user and the display. Still in another aspect, the threshold is determined based on characteristics of the user. Alternatively, the threshold is determined based on the type of the content on display viewed by the user, time of a day, day of a week, whether it is school day or break day, location, motion, acceleration, orientation, brightness, temperature, gravity, surrounding sound level, or magnetic field. In some aspects, the threshold is set, at any time, by the administrator.

Yet in another aspect, the display is deactivated in response to a request from the administrator. Such a request, in one aspect, is transmitted over a network.

In certain embodiments, the method further comprises restoring the display after the display is deactivated. In one aspect, the display is restored after a time limit following the deactivation. The time limit can be predetermined or determined based on the overall time before the deactivation, without limitation. In another aspect, the display is restored, at anytime after deactivation, upon receiving an authorization to restore the display or an appropriate response from the user in response to a request for action.

In another embodiment, the device is configured to retrieve a user profile for the user. In one aspect, the user profile comprises one or more of the user's characteristics selected from the group consisting of name, age, gender, race, color, ethnicity, facial characteristics, eye colors and voice. In another aspect, the user profile further comprises the user's history of viewing the display.

In one aspect, the method is further configured to recognize the user and match the user to the user's profile. In another aspect, the method is configured to use the user profile to adjust the threshold. In yet another aspect, the method is configured to classify the user profile into one or more of a plurality of user categories. In one such aspect, the method is configured to use the classification to adjust the threshold.

In another aspect, the method is configured to transmit information concerning the user and/or the viewing history to a remote computing device. In yet another aspect, the administrator is allowed to view such information.

### BRIEF DESCRIPTION OF THE DRAWINGS

Provided embodiments are illustrated by way of example, and not limitation, in the figures of the accompanying drawings in which:

FIG. 1 presents an exemplary configuration for determining whether a user is viewing an electronic display;

FIG. 2 illustrates a method for determining whether a user's pupils are actually viewing an electronic display; and

FIG. 3 shows that the overall time during which a user views an electronic display can be continuous or accumulative including one or more resting periods.

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION OF THE DISCLOSURE

As used herein, certain terms have the following defined meanings. Terms that are not defined have their art recognized meanings

As used in the specification and claims, the singular form “a”, “an” and “the” include plural references unless the context clearly dictates otherwise.

As used herein, the term “comprising” is intended to mean that the compositions and methods include the recited elements, but not excluding others. “Consisting essentially of” when used to define compositions and methods, shall mean excluding other elements that would materially affect the basic and novel characteristics of the technology. “Consisting of” shall mean excluding any element, step, or component not specified in the claim. Embodiments defined by each of these transition terms are within the scope of this disclosure.

A “processor” is an electronic circuit that can execute computer programs. Examples of processors include, but are not limited to, central processing units, microprocessors, graphics processing units, physics processing units, digital signal processors, network processors, front end processors, coprocessors, data processors and audio processors.

A “memory” refers to an electrical device that stores data for retrieval. In one aspect, a memory is a computer unit that preserves data and assists computation.

An “electronic display” or “electronic screen” refers to any electronic device that displays a visual signal that can be viewed by human eyes. Non-limiting examples include cell phone screens, tablet screens, television screens, desktop computer screens, laptop computer screens, reading device screens, personal digital assistant screens, portable media player screens, portable gaming device screens, and any other powered external screen displaying outputs of the wired or wireless connected devices.

A “user” refers to any person that uses or views an electronic display.

An “administrator,” as used here, refers to any person that has access to a user's electronic display, either locally or remotely, to deactivate and/or restore the display, where the administrator can be the same as or different from the user of the display. In some embodiments, an administrator has the right to deactivate and restore the display at any time. Such a right can be implemented with methods known in the art, such as but not limited to, appropriate authorization code or login credentials.

As used herein, “deactivating an electronic display” refers to any change to the content displayed on an electronic display such that a user is unable to view the content as the user normally desires. In one aspect, deactivating an electronic display is altering, blocking, or dimming at least part of the content displayed on the display. In another aspect, deactivating an electronic display is activating a screensaver on the display. In yet another aspect, deactivating an electronic display is showing a warning message on the display. In yet another aspect, deactivating an electronic display is turning off or blanking the display.

A “screensaver” refers to a computer program configured to prevent phosphor burn-in on electronic displays by blanking the screen or filling it with moving images or patterns when the display is not in use.

### DETAILED DESCRIPTION

People, in particular, children tend to watch electronic displays too closely and/or for too long. A proper watching distance and limited continuous viewing of screens can help reduce radiation effects and maintain a good vision. This disclosure provides apparatuses and methods to correct such unhealthy use of electronic displays or at least alert the user to promote a more healthy use.

In one embodiment, the provided methods entail utilizing face detection tools to detect human faces from other objects, and distance sensors to determine a user's distance from the display. Additionally, eye motion detection mechanism can be used to determine watching duration. According to both watching distance and duration, the display can be deactivated and restored.

One embodiment of the present disclosure provides a method for limiting the use of an electronic display. In one aspect, the method entails determining whether a user is viewing an electronic display by obtaining the location of the user relative to the display, measuring the overall time during which the user views the display, and deactivate the display when the overall time reaches a threshold or in response to an administrator's request. Devices and program codes stored in computer-readable media are also provided for carrying out the method of the present disclosure.

A. Determination of Whether a User is Viewing an Electronic Display

Determination of whether a user is viewing an electronic display can be carried out by obtaining, e.g., by a distance sensor, the distance between the user and the display, or further by determining whether the user, in particular the user's eyes is within a viewing location relative to the display. In a further aspect, the determination can be made by examining whether the pupils of a user's eyes are directed to a direction that intersects with the display.

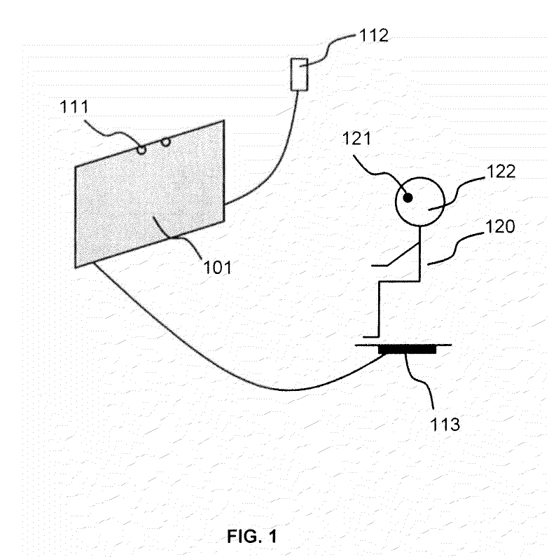

An exemplary setup illustrating the utility of the present disclosure, which includes an electronic display and devices for detecting a user's viewing of the display, is shown in FIG. 1. While the user 120 is viewing the electronic display (e.g., TV) 101, a sensor can be used to detect the distance and/or direction of the user 120 (or the user's eyes 121 or face 122) relative to the display. The sensor can be a sensor 111 that is placed on top of the display or built in within the display, or a sensor 112 that is placed aside the display, which is in electronic communication (such as wired or wireless communication) with the display 101, or a computing device connected to the display. Likewise, a sensor 113 that is placed under the user can be used. In this respect, if the sensor 113 moves long with the user, the location of the user can be determined by virtue of the location of the sensor. In some aspects, multiple sensors (e.g., cameras) can be used to improve the detection accuracy.

A variety of sensors can be used to measure distance and directions. For instance, optical lenses, as part of a camera which can be built in within a cellular phone, can detect the distance and direction optically. Sensors that use ultrasound, infrared light, orientation, light, proximity are also known in the art.

Alternative methods for the measurement of the distance between the user and the display are also provided. In one aspect, a mat is placed on the floor that checks for pressure if someone comes too close to the display. In another aspect, proximity sensor based human infrared radiation can be used. In another aspect, multiple cameras are used to measure watching distance. Still further, face detection is used to filter out human beings and animals. Alternatively, radio frequency (RF) waves can be used, for instance, when a user enters a region and thus blocks the transmission. Magnetic field, in yet another aspect, is used to monitor the intrusion of a prohibited region of screen. It is noted that sensors and measurement devices can include those built in the screen and external to the screen.

In one example, measuring the distance between the user's eyes and the electronic display starts with detecting the user's face. Face detection methods and tools are also known in the art. Once the face is detected, the sensor can then detect the eyes in the face, and measure the distance between the eyes. The distance between the eyes can then be used to measure the distance between the user and the display. Alternatively, the distance between the user and the display can be calculated with the length or width of the user's nose, distance between the two ears, eye brow width, glasses width, or height or width of the face, without limitation.

Briefly, assuming the focal length (f) once the user's eyes are focused on the sensor's image forming plane, is readily available to the sensor, and the actual distance (h) between the user's two eyes can be manually obtained from the user, from a user profile, or assumed with an average value, then once the imaged distance (l) between the user's two eyes is determined on the sensor, the distance (d) between the user and the display can be obtained with the following equation:

$$\frac{l}{h} = \frac{f}{d} .$$

Alternatively, the actual distance between the two eyes of the user can be obtained by aligning the two eyes to two points on the screen. As the distance between the two points can be measured, the actual distance between the user's eyes is also determined. In another aspect, the user can input such data in the user's profile, which is accessible to the display or a computing device controlling the display.

In one aspect, whether a user is viewing a display is determined by the distance between the user and the display. In some aspect, the distance is a minimum distance between the face of the user and the display. In some aspect, the distance is a minimum distance between either of the user's eyes, or the pupils, and the display.

For instance, if the distance is smaller than a distance limit, then the user is presumed to be viewing the display. A “distance limit,” as used herein, refers to a threshold distance value between an electronic display and a user, within which the user is considered viewing or using the display and beyond which the user is considered not viewing or using the display. Such a distance limit, in one aspect, can be predetermined. For instance, for a large screen TV, the distance limit can be about 10 feet, 20 feet, 30 feet or 40 feet. For a cellular phone, the distance limit can be about 6 inches, 1 foot, 1.5 feet, without limitation. The determination of the distance limit, in one aspect, can be based upon the user's characteristics, such as age.

In another aspect, the distance limit is determined or adjusted on the fly, base upon, without limitation, location, motion, acceleration, orientation, brightness, temperature, gravity, surrounding sound level, or magnetic field in the environment. In yet another aspect, the distance limit is dependent upon the brightness of the display, color of the display, display size, display's aspect ratio, font size, time zone, religion restrictions, weather, or whether it is a holiday.

In some embodiments, the sensor is configured to detect the direction of the user relative to the display. In this context, it is contemplated that a user (or the user's face, eyes, or pupils) that is right in front of the display is more likely to be viewing the display than one whose face's projection does not fall into the display.

In yet another aspect, the sensor detects the location of the user's pupils relative to both the user's eyes and the display. Further, eye motion and eye blinking can also be sensed and used in determining whether the user is actively viewing the display. Methods to this end are known in the art and further illustrated below. The term “actively viewing” intends that a user is not only looking at a direction that intersects with the display, but also is paying attention to the content displayed on the display.

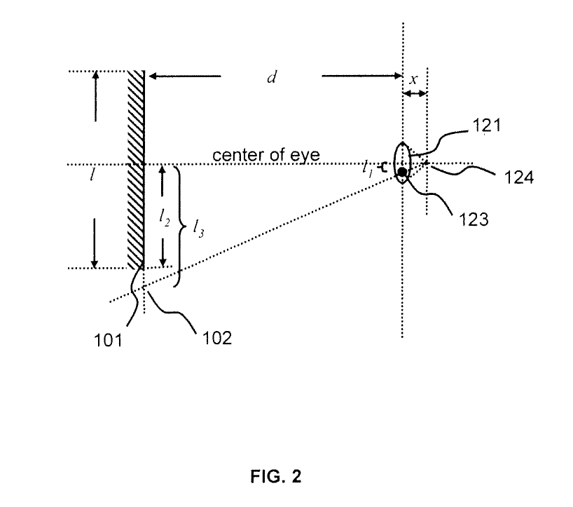

With reference to FIG. 2, whether a user is actually viewing a display can be determined by a sensor. When a user is “actually viewing” a display, the user is not just within a distance limit from the display but also with the eyes looking at a direction that intersects with the display. In this example, the vertical center of the eye 121, when projected onto the plane of the display 101, falls into the display. Also as shown in FIG. 2, the pupil 123 in the eye 121 is below the center of the eye, with an offset of l₁. The distance between the projection point of the center of the eye and the lower edge of the display is denoted as l₂ and the height of the display is l. Further, let d denote the distance between the horizontal center of the outer surface of the eye and the display, and let x denote the distance between the horizontal center of the outer surface of the eye and the center 125 of the eye ball. With these measurements, the spot 102 on the display plane where the eye is looking through can be calculated with a distance l₃ from the projection of the center of the eye, because:

$$\frac{{l}_{3}}{{l}_{1}} = \frac{d + x}{x} .$$

In the event when l₃>l₂, therefore, it can be determined that the eye is not viewing the display (as shown in FIG. 2); otherwise, when l₃<l₂, it can be determined that the eye is viewing the display. The viewing angle of the other eye of the user can be likewise determined and can be used to further confirm whether the user is viewing the display.

B. Overall Viewing Time and Threshold

In one embodiment, the display is deactivated when the overall viewing time (duration) has reached a threshold. In a particular aspect, anytime since the display is turned on is counted towards the overall time. In other words, the display will be deactivated after the threshold time is reached, whether or not the user is actually viewing the display. Alternatively, however, only time during which the user is viewing, such as being presumed to be viewing by virtue of the user's distance to the display, actively viewing, or actually viewing, the display is counted towards the overall time.

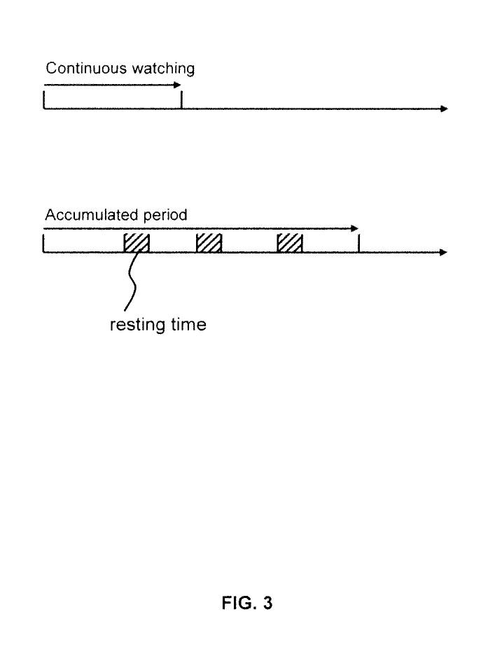

For instance, as illustrated in FIG. 3, the overall time can be the duration during which the user continuously views the display (upper panel) or the accumulative duration, which is the total time minus the resting time periods (bottom panel).

The threshold can be predetermined or determined on the fly. When the threshold is predetermined, the determination can be made based on various factors including the user's characteristics, the display's type and the conditions of the surrounding area. For instance, the threshold can be determined based on, without limitation, the type of the content on display viewed by the user, time of a day, day of a week, whether it is school day or break day, location, motion, acceleration, orientation, brightness, temperature, gravity, surrounding sound level, or magnetic field.

In another embodiment, the threshold can be determined or adjusted on the fly. For instance, the threshold can be shortened if the distance between the user and the display is considered lower than desired. In a particular aspect, the threshold is set to zero if the distance is below a critical level. Like the distance limit, the critical level can be determined by a variety of methods. In one aspect, the critical level can be calibrated. In this context, a user stays at a minimum proper distance and then signals the system (e.g., by pressing a button) that a critical level is reached.

In yet another embodiment, the threshold can be adjusted by an administrator at any time.

C. Deactivation and Restoration of the Electronic Display

As provided, as used herein, “deactivating an electronic display” refers to any change to the content displayed on an electronic display such that a user is unable to view the content as the user normally desires. In one aspect, the display is deactivated when the overall time reaches the threshold. In another aspect, the display is deactivated in response to a request from an administrator. The response can be local or transmitted over a network. In some aspects, the devices or methods of the present disclosure are configured to allow the administrator to read the user's viewing history, user profile, and/or condition or status of the display, without limitation. To this end, in one aspect, the administrator sends the request based on such information.

In one aspect, the deactivation comprises displaying a warning message on the display or turning off the display. In another aspect, the deactivation comprises starting a screensaver. Non-limiting examples of a screensaver include a completely blocked screen, a sleep or standby mode screen, or a dimmed screen with warning messages, providing instructions to remove the screensaver. Other non-limiting examples of deactivating a display include interrupting the supply, update, or refreshing of content on the display or interaction of the user with the display, such as disabling the internet connection, stopping one or more programs from launching or refreshing, pausing one or more programs from continuous use, killing one or more programs, disabling a touch screen from accepting inputs, disabling keyboard, disabling trackball, disabling remote control, disabling connected controller, disabling video input or output, or disabling sensors required for interaction with the display.

In another aspect, the deactivation comprises displaying a content on the display that is different from what has been displayed before the deactivation. In some embodiments, the content is provided by a server, transmitted to the display over a network.

In one aspect, the display is restored (e.g., the screensaver is disabled), at any time, by a correct pass code. The display can also be deactivated if the viewer is staying at proper watching distance. For situations where a mandatory break is enforced, the screensaver will be automatically deactivated when the break is over.

After the display is deactivated, the display can be restored upon occurrence of any one or more of the following events. In one aspect, the user adjusts himself or herself to a more healthy viewing distance. In another aspect, the display is restored after a certain time period, which can be predetermined and/or adjusted based on factors which are considered for deactivating the display, such as the user's characteristics, the type and content of the display, or conditions of the viewing environment, without limitation.

In one aspect, the amount of time to wait before the display is restored depends on how the display was deactivated. For instance, if the display was deactivated after continuous use, the waiting time can be longer. By contrast, if the display was deactivated after discontinuous use, the waiting time can be shorter.

In yet another aspect, the display is restored upon receipt of appropriate authorization. For instance, the user or the administrator can restore the display with a correct passcode or a correct voice command. Alternatively, the user or the administrator can adjust parameters, such as restoration time or distance, to achieve restoration. Further, such parameters can also be adjusted based on factors such as the user's characteristics, the type and content of the display, or conditions of the viewing environment, without limitation, which factors can be stored in a user profile, as further discussed below, detected automatically, or input manually. In some aspects, the deactivated display shows a request for the user to comply with, such as “sing Jingle Bells.” Accordingly, after the user complies with the request, the user can type, e.g., “Completed”, to restore the display.

D. User Profiles

The present disclosure also provides multiple levels of user profiles to improve performance. The following profiles, for instance, can be used:
Group profile: this includes the characteristics of a group of users, i.e., grouping people by age, gender, race, and other physical characteristics. The characteristics associated with a group can be eye width, nose length, eye color, skin color, etc;
Personal profile: face recognition, fingerprint recognition, iris recognition, or voice recognition. When a screen is used by multiple users, each user can be recognized and the system can apply his/her personalized/customized preferences in view distance and duration; and
Universal profile: identical to any user. When an unknown face shows up and it cannot be classified, universal profile is applied.

In one embodiment, the device or the method of the present disclosure is configured to retrieve a user profile for the user that is viewing the display. Such a user profile, in some aspects, can be used to determine or adjust certain conditions of the devices or methods, such as the distance limit, time threshold and restoration mechanisms.

In one aspect, the user profile comprises one or more of the user's characteristics selected from the group consisting of name, age, gender, race, color, ethnicity, facial characteristics, eye colors and voice. In another aspect, the user profile further comprises the user's history of viewing the display.

In one embodiment, the device or method of the present disclosure is further configured to recognize the user and match the user to the user's profile.

In another embodiment, the device or method of the present disclosure is configured to classify or cluster the user profiles into categories or groups, which categories and groups can then be used to adjust certain attributes of the user profiles or adjust the distance limit and/or time threshold, as appropriate.

E. Computer Network and Access to Information

In one embodiment, the device or method of the present disclosure is configured to transmit information concerning the user and/or the overall time to a remote computing device. Such information can then be viewed, edited, and/or mined by authorized users. In one aspect, an authorized user, such as the user's parent, is allowed to view the information. As provided above, the authorized user can then adjust certain parameters, such as distance limit and time threshold, based on such information.

It will be appreciated by the knowledgeable reader that systems and methods of the present disclosure can be implemented on any computer network. In some aspect, information exchange over the computer network is carried out through secure data communication. Methods and devices for providing secure data communication are well known in the art.

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A custom computing device for limiting the use of an electronic display, comprising a processor, a memory, and program code which, when executed by the processor, configures the device to:
determine whether a user is viewing an electronic display by obtaining the location of the user relative to the display,
measure the overall time during which the user views the display, and
deactivate the display when the overall time reaches a threshold or in response to an administrator's request.

2. The device of claim 1, wherein the location of the user relative to the display comprises a distance between the user and the display and the user is determined as viewing the display if the distance is smaller than a distance limit.

3. The device of claim 1, wherein the location of the user comprises the locations of the pupils of the user relative to the display.

4. The device of claim 1, wherein the overall time is continuous.

5. The device of claim 1, wherein the overall time is accumulative time during which the user views the display.

6. The device of claim 1, wherein the deactivation comprises starting a screensaver.

7. The device of claim 1, wherein the deactivation comprises displaying a warning message on the display, turning off the display, or displaying a content that is different from what has been displayed before the deactivation.

8. The device of claim 1, wherein the display is deactivated when the overall time reaches the threshold.

9. The device of claim 8, wherein the threshold is predetermined.

10. The device of claim 8, wherein the threshold is determined based on the distance between the user and the display.

11. The device of claim 8, wherein the threshold is determined based on characteristics of the user.

12. The device of claim 8, wherein the threshold is determined based on the type of the content on display viewed by the user, time of a day, day of a week, whether it is school day or break day, location, motion, acceleration, orientation, brightness, temperature, gravity, surrounding sound level, or magnetic field.

13. The device of claim 8, wherein the threshold is set, at any time, by the administrator.

14. The device of claim 1, wherein the display is deactivated in response to a request from the administrator.

15. The device of claim 14, wherein the request is transmitted over a network.

16. The device of claim 1, further comprising restore the display after the display is deactivated.

17. The device of claim 16, wherein the display is restored after a time limit following the deactivation.

18. The device of claim 17, wherein the time limit is predetermined.

19. The device of claim 17, wherein the time limit is determined based on the overall time before the deactivation.

20. The device of claim 16, wherein the display is restored, at anytime after deactivation, upon receiving an authorization to restore the display or an appropriate response from the user in response to a request for action.

21. The device of claim 1, wherein the device is configured to retrieve a user profile for the user.

22. The device of claim 21, wherein the user profile comprises one or more of the user's characteristics selected from the group consisting of name, age, gender, race, color, ethnicity, facial characteristics, eye colors and voice.

23. The device of claim 22, wherein the user profile further comprises the user's history of viewing the display.

24. The device of claim 21, wherein the device is further configured to recognize the user and match the user to the user's profile.

25. The device of claim 21, wherein the device is configured to use the user profile to adjust the threshold.

26. The device of claim 21, wherein the device is configured to classify the user profile into one or more of a plurality of user categories.

27. The device of claim 26, wherein the device is configured to use the classification to adjust the threshold.

28. The device of claim 1, wherein the device is configured to transmit information concerning the user and/or the viewing history to a remote computing device.

29. The device of claim 28, wherein the administrator is allowed to view the information.

30. A method for limiting the use of an electronic display, comprising:
determining, by a computing device, whether a user is viewing an electronic display by obtaining the location of the user relative to the display,
measuring the overall time during which the user views the display, and
deactivating the display when the overall time reaches a threshold or in response to an administrator's request.

31. A non-transitory computer readable medium comprising program code which, when executed,
determining whether a user is viewing an electronic display by measuring the location of the user relative to the display,
measuring the overall time during which the user views the display, and
deactivating the display when the overall time reaches a threshold or in response to an administrator's request.
